(19) United States
(12) Patent Application Publication
(10) Pub. No.: US 2026/0226230 A1
(43) Pub. Date: Aug. 6, 2026

(54) FLAME RETARDANT COPOLYMER WITH ONE OR MORE NON-VIRGIN FOSSIL COMPONENTS AND METHODS OF MAKING THE SAME

(71) Applicants: Joerg DAHRINGER, Bobingen (DE); Prashant DESAI, Bangkok (TH); Werner GRASSER, Stadtbergen (DE); Nick CARTER, Holzgerlingen (DE); Indorama Ventures Public Company Limited, Bangkok (TH)

(72) Inventors: Joerg Dahringer, Bobingen (DE); Prashant Desai, Bangkok (TH); Werner Grasser, Stadtbergen (DE); Nick Carter, Holzgerlingen (DE)

(21) Appl. No.: 19/146,154

(22) PCT Filed: Jan. 5, 2024
(86) PCT No.: PCT/EP2024/050233

§ 371 Date: Jul. 7, 2025

Related U.S. Application Data
(60) Provisional application No. 63/437,708, filed on Jan. 8, 2023.

(51) Int. Cl. C08G 63/692; C08G 63/78; D01F 6/84; D02G 3/44

(52) U.S. Cl. CPC C08G 63/6926; C08G 63/78; D01F 6/84; D02G 3/443; D10B 2331/04

(57) ABSTRACT

The present invention is directed to a flame retardant recycled PET (rPET) copolymer that incorporates a (BHET) component without using any virgin purified terephthalic acid (PTA), virgin dimethyl terephthalate (DMT) and/or virgin fossil monoethylene glycol (MEG), and compositions created by the method, including polymeric materials, polymeric fibrous materials such as used for manufacture of non-woven fabric and like materials.

### TECHNICAL FIELD

The present invention relates generally to flame retardant copolymers, and more specifically to copolymers containing one or more non-virgin fossil components combined with one or more flame retardant monomer chemistries, for use in flame retardant fibers, filaments, and fabrics, wherein the non-virgin fossil components are obtained from recycled, reclaimed or bio-sourced monomer.

### BACKGROUND OF THE INVENTION

Polymer materials are widely used throughout the world and are industrially mass-produced. Due to many and varied functional and aesthetic properties that can be designed into such polymer materials, the usage of polymer materials is increasing greatly year over year. Within such polymer materials, thermoplastic or thermoset polymer resins are suitable to produce shaped article from such materials. One of the benefits of such materials is that such materials have a great ability to withstand the forces of nature, however, such benefit turns into an environmental disadvantage when such materials are accumulated in waste streams. For example, fibers, such as textile fibers, produced from polymer resins do not naturally biodegrade in the same manner as natural fibers such as cotton and wool, and can remain in landfills for decades and even longer. Thus, that which makes plastics so attractive has led to the potential for serious lingering environmental problems.

Due to the large amounts of polymer materials used world-wide and especially due to the unsafe release to the nature in many countries, accumulation of waste polymers has occurred at an alarming pace. Efforts to efficiently convert waste polymers into usable component materials for the production of new polymers are ongoing.

The megatrend for sustainability shows the desire for high-performance products with a “green soul”, which services the required specification. The textiles industry needs to further expand its efforts in addressing waste, minimizing over production, and the creation of “one-way” items or waste. The word “used” is over-used . . . the raw material needed to produce textiles can be reprocessed without requiring absolute reliance on fossil fuels. Solutions to these issues are two-fold-by building upon advanced recycling and bio-based raw materials. Advanced Recycling is a process and technology which can address two issues: waste reclaim and reduction on fossil fuel exploitation. If chemical molecules used in products can later be “freed” and used again in a new product, we have realized a new “transient state” of the components. The performance and aesthetic qualities of the consumer products our industry produces are key to the market and need to perform/function indifferent of the raw material fed used-whether virgin or recaptured.

Within the aforementioned polymer materials, polycondensates such as polyesters, are a certain class of polymer materials. Within the polyesters, polyethylene terephthalate (PET) is widely used for various purposes. Therefore, the recycling of PET is of particular interest to overcome the aforementioned environmental problems. One possibility for PET recycling is separating and collecting used PET materials. However, such mechanical recycling is limited due the various additives being present on PET. Consequently, chemical recycling of PET is more suitable and allow the production of customized fresh PET products.

As described in EP 0723951 A1, chemical recycling of PET can be done by i) acidic or basic hydrolysis, ii) methanolysis or iii) glycolysis. Method (i) uses water as the reagent together with PET and can be used to obtain terephthalic acid (TA) and ethylene glycol (EG) as reaction products (U.S. Pat. No. 3,501,420, 1970). However, the reaction occurs only at high temperatures in the presence of strong concentrations of powerful acids or bases. Method (ii) uses methyl alcohol as a reagent that converts PET into a dimethyl terephthalate (DMT) monomer and ethylene glycol. This type of process has been widely studied and the technology for such a process has been developed, however PET reacts with methyl alcohol, in the presence of catalyzers, only at high temperatures (220-250° C.) and pressures (U.S. Pat. No. 3,403,115, 1968). This involves risks regarding the use of methyl alcohol under such drastic conditions. In fact, it is well known that methyl alcohol is highly explosive at high temperatures and pressures. In addition, methyl alcohol is toxic if inhaled or if it comes in contact with the skin, eyes, etc. In method (iii) waste PET reacts with ethylene glycol with the formation of a mix of PET oligomers that then can be used directly, without any purification, to produce new PET (U.S. Pat. No. 4,609,680, 1986; U.S. Pat. No. 3,222,299, 1965). This method requires relatively mild reaction conditions (220° C., atmospheric pressure, use of EG) but, since the products obtained are not purified, it cannot eliminate the impurities and contamination (for example catalytic residues, dyes, various additives, diethylene glycol, etc.) found in the waste PET used. Therefore, the depolymerization by glycolysis towards bis(2-hydroxyethyl) terephthalate (or bis-hydroxyethyl terephthalate or bis ethylene glycol terephthalate) hereinafter indicated by the acronym “rBHET” has become of interest, as such BHET can be used as monomer and polymerized in the production of PET.

PET obtained from BHET as a monomer, is produced in a single stage, and therefore using systems that are simpler than the traditional methods (in two stages). Thus, it is possible to eliminate the reactor of the first stage, and to avoid adding the substances that are usually added and cancel or eliminating the first stage of the process and the relative catalyzers and their potentially negative effects. BHET, as a pure and chemically well-defined product, can be used in the polycensation towards PET and, provided the BHET has no impurities, is a good starting material for producing PET.

WO 2021/032826 A1, which is incorporated by reference herein in its entirety, describes a process of recycling polyethylene terephthalate (PET) into a monomer compound for the manufacture of PET. Specifically, bis(2-hydroxyethyl) terephthalate (BHET) can be produced by the catalytic glycolysis. However, the BHET purification from crude BHET which is directly obtained from the depolymerization of PET by glycolysis, is complex.

WO 2016/140901 A1 and U.S. Pat. No. 11,352,718, which are each incorporated by reference herein in their entireties, define the terms bio-based or bio-derived monoethylene glycol (bio-MEG) and bio-based or bio-derived purified terephthalic acid (PTA) the use thereof in PET polymer synthesis.

PET is used in various products and in various applications. One use of PET is in the field of flame-retardant fibers and textiles. These flame-retardant textiles are typically produced with a PET synthesized with components such as PTA and/or MEG from a virgin fossil-source, and there exists a need to have flame-retardant modified PET from recycled PET materials. Thus, there remains an unmet need for the use of recycled waste polymer components and/or bio-sourced polymer components which are able to substitute or replace conventional, virgin fossil or undegraded, polymer component materials in the manufacture of high-quality polymers for use in flame retardant applications. Such materials should be compatible to the existing production technologies and equipment to advantageously reduce demand on virgin fossil components while avoiding extensive capital expenditures.

Through advancement of the technology have now developed a means for future using non-virgin components obtained from recycled source, reclaimed source, bio-sourced, and the combinations there of. The chemistries and methods of obtaining functional flame-retardant PET by polycondensation from virgin-fossil components is well known and described, for example in U.S. Pat. Nos. 3,853,819, 4,035,343, and RE30783 which are each incorporated by reference herein in their entireties.

### SUMMARY OF THE INVENTION

The present invention is directed to methods of manufacturing a flame retardant recycled PET (rPET) copolymer by polycondensation of a non-virgin fossil based BHET and phosphorus functional comonomer as flame-retardant functional additive. The invention also encompasses compositions created by the methods, including polymeric materials, polymeric fibrous materials such as those used for manufacture of non-woven fabric and like materials, and the fabrics comprising such polymeric fibrous materials.

Other features and advantages of the present invention will become apparent from the following more detailed description, taken in conjunction with the accompanying drawings, which illustrate, by way of example, the principles of the invention.

### DETAILED DESCRIPTION OF THE INVENTION

The present invention provides for a flame-retardant recycled PET (rPET) copolymer by polycondensation of a non-virgin fossil based BHET and phosphorus functional comonomer as flame-retardant functional additive. In the present invention, the non-virgin fossil based BHET is a monomeric rBHET. In addition, by using the instant monomeric rBHET, various parameters of the flame-retardant recycled PET (rPET) copolymer obtained according to the instant invention can be adapted and set, which is typically only partially possible by significant changes of the production processes involved or by other additional measures increasing the costs for production.

In a preferred embodiment of the invention, the invention provides for a flame-retardant recycled PET (rPET) copolymer by polycondensation of i) monomeric rBHET and ii) phosphorus functional comonomer, without adding a) any virgin fossil purified terephthalic acid (PTA), or b) virgin fossil dimethyl terephthalate (DMT), or c) virgin fossil monoethylene glycol (MEG). The flame-retardant recycled PET (rPET) copolymer obtained by using the instant monomeric rBHET can be specifically adapted and designed with respect to various parameters, which are typically only partially possible and require-inter alia-significant changes of the commercial production processes involved or by other additional measures increasing the costs for production.

Purified terephthalic acid (PTA) is a so called “fiber-pure” terephthalic acid (purified terephthalic acid, PTA) and contains <25 ppm 4-CBA (4-Carboxybenzaldehyde) and has a purity of >99.99%.

In general, fossil materials can be easily differentiated from bio-based or bio-derived sources materials by their carbon 14 (C14) isotope pattern.

Virgin fossil purified terephthalic acid (PTA) is PTA obtained starting from fossil resources, for example crude oil or natural gas, and is not a bio-based or bio-derived materials as defined in WO 2016/140901 A1 and U.S. Pat. No. 11,352,718, which are each incorporated by reference herein in their entireties, define the terms bio-based or bio-derived. Fossil PTA can be easily differentiated from PTA from bio-based or bio-derived sources by their carbon 14 (C14) isotope pattern.

Virgin fossil dimethyl terephthalate (DMT) is DMT obtained starting from fossil resources, for example crude oil or natural gas, and is not a bio-based or bio-derived materials as defined in WO 2016/140901 A1 and U.S. Pat. No. 11,352,718, which are each incorporated by reference herein in their entireties, define the terms bio-based or bio-derived. Fossil DMT can be easily differentiated from DMT from bio-based or bio-derived sources by their carbon 14 (C14) isotope pattern.

Virgin fossil monoethylene glycol (MEG) is MEG obtained starting from fossil resources, for example crude oil or natural gas, and is not a bio-based or bio-derived monoethylene glycol (bio-MEG) as defined in WO 2016/140901 A1 and U.S. Pat. No. 11,352,718, which are each incorporated by reference herein in their entireties, define the terms bio-based or bio-derived. Fossil MEG can be easily differentiated from MEG from bio-based or bio-derived sources by their carbon 14 (C14) isotope pattern.

In a further embodiment, the invention is directed to a method which further utilizes a non-antimony catalysis so as to remove the potential for further inclusion of antimony into the resultant flame-retardant rPET copolymer.

The phosphorus functional comonomer used as flame-retardant functional additive in the instant invention can be any phosphor/phosphorous-based comonomer providing such flame-retardant functionality and which can be used in the polycondensation of the rBHET. Suitable phosphor/phosphorous-based comonomer are described in U.S. Pat. Nos. 3,853,819, 4,035,343, and RE30783.

Preferred phosphorus functional comonomers are the compounds as defined in Formula (I) and/or Formula (II)

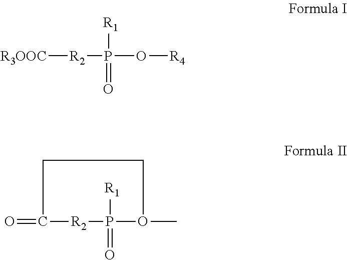

in which the radicals have the following meaning
R¹ is equal to alkyl, aryl, alkyl-aryl, aryl-alky, preferably C₁-C₁₀-alkly or C6-C10-aryl, more preferably CH₃ or C₆H₅,
R² is equal to —(CH₂)ₓ—,
x being an integer from 1 to 6, preferably x=2
R³, R⁴ is equal to H, —(CH₂)_{y}—OH, (CH₂)_{z}—O—(CH₂)_{z}OH, preferably (CH₂)₂—OH, (CH₂)₂—O—(CH₂)₂OH, CH₂—CH₂—CH₂—CH₂OH, CH₂—CH₂—CH₂OH
y being an integer from 1 to 6, preferably from 1 to 4,
z being an integer from 1 to 6, preferably from 1 to 4, more preferred z is 2.

A particular preferred phosphorus functional comonomer is 3-(hydroxyphenylphosphinyl) propanoic acid (3-HPP):

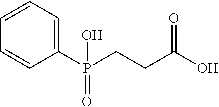 [SMILES: O=C(O)CCP(=O)(O)c1ccccc1]

The phosphorus functional comonomers are present in the flame retardant recycled PET (rPET) copolymer in an amount ranging from 0.01 to 3 wt. % phosphor content based on total weight of polymer material.

By using rBHET having a defined profile, various parameters of the flame-retardant recycled PET (rPET) copolymer obtained according to the instant invention can be adapted and set, which are typically only partially possible and require—inter alia—significant changes of the commercial production processes involved or by other additional measures increasing the costs for production. Hence, the use of the instant monomeric rBHET allows to adapt and to control the properties of the flame-retardant recycled PET (rPET) copolymer thus obtained.

The monomeric rBHET material used in the instant invention comprises
(i) at least 75 weight-% of bis(2-hydroxyethyl) terephthalate (BHET), preferably at least 90 weight-% of bis(2-hydroxyethyl) terephthalate (BHET), based on the dry weight of the monomeric rBHET material and,
(ii) 0.3 to 8 weight-% of mono(2-hydroxyethyl) terephthalate (MHET), preferably 0.3 to 2.5 weight-% of mono(2-hydroxyethyl) terephthalate (MHET), based on the dry weight of the monomeric rBHET material and,
(iii) 1 to 20 weight-% of linear oligomers, preferably 1 to 8 weight-% of linear oligomers, based on the dry weight of the monomeric rBHET material, and,
(iv) optionally 0.001 to 0.1 weight-% cyclic oligomers, based on the dry weight of the monomeric rBHET material and,
(v) a carboxyl end group (CEG) content from 8 to 70 mmol/kg, preferably from 15 to 50 mmol/kg, and,
(vi) a saponification value corresponding to a range from 430 to 450 mg KOH/g and;
(vii) 0.1 to 2.5 weight-%, preferably 0.1 to 2.0 weight-%, more preferred 0.5 to 1.6 weight-%, of diethylene glycol (DEG).

By using the above monomeric rBHET it is possible to produce flame-retardant recycled PET (rPET) copolymer having a low residual diethylene glycol (DEG) content of less than 1.45 weight-%, preferably 1.4 weight-% or less, more preferred 1.3 weight-% or less, more preferred 1.2 weight-% or less, based on the weight of the final flame-retardant recycled PET (rPET) copolymer. In contrast, commercially available flame-retardant PET copolymer, typically, have a residual diethylene glycol (DEG) content of 1.48 to 1.5 weight-% of residual diethylene glycol (DEG).

In addition, it is surprising that by using the above monomeric rBHET even higher phosphorous content in the flame-retardant recycled PET (rPET) copolymer are possible, even the presence of such phosphorous materials contributes to the formation of residual diethylene glycol (DEG) in the polymer. Thus, by using the above monomeric rBHET comprising up to 2.5 weight-%, preferably 1.5 to 2.5 weight-%, more preferred 1.8 to 2.5 weight-%, of diethylene glycol (DEG), flame-retardant recycled PET (rPET) copolymers having a phosphorous content of at least 6700 mg/kg are possible, preferably such flame-retardant recycled PET (rPET) copolymers having a melting temperature of below 242° C., in particular below 240° C.

In addition, and for specific purposes needed, a higher residual diethylene glycol (DEG) content may be desired in flame-retardant PET copolymers; this can also be controlled by using a monomeric rBHET having the above set of parameters, except for a higher diethylene glycol (DEG) content being in the range from 1.5 weight-% to up to 8 weight-% of diethylene glycol (DEG) for producing flame-retardant recycled PET (rPET) copolymer having a higher residual diethylene glycol (DEG) content.

Further, by selecting the diethylene glycol (DEG) content of the monomeric rBHET in combination within the other set of parameters, a flame-retardant recycled PET (rPET) copolymer can be obtained having an improved dyeability of the fiber obtained from such flame-retardant recycled PET (rPET) copolymer. This provides for an additional control of the later dyeing process of the fibers formed from such flame-retardant recycled PET (rPET) copolymer.

In the manufacture of known flame-retardant PET copolymer, the diethylene glycol (DEG) is primarily formed during the esterification reaction which is typically under acidic conditions. In order to control the diethylene glycol (DEG) content, process conditions can be adapted or changed, however, this is a complex operation and leads to higher costs in commercial operations, beside potential quality deviations of the final product. Hence, the instant specified monomeric rBHET provides for a controlled pathway to manufacture flame-retardant recycled PET (rPET) copolymer.

Typically, the diethylene glycol (DEG) content in the manufacture of known flame-retardant PET copolymer is about 1.48-1.5 wt.-% DEG. Such residual diethylene glycol (DEG) content impacts beside other properties, also the dyeability of the fiber obtained from such materials. With the instant invention, the use of the instant monomeric rBHET allows to set the residual diethylene glycol (DEG) from the beginning.

In order to obtain flame-retardant recycled PET (rPET) copolymer having a higher residual amount of DEG (>1.6 wt.-% DEG), the diethylene glycol (DEG) content of the monomeric rBHET is selected at least 1.5 wt-%, more preferred of 1.6 wt-%, in combination within the other set of parameters.

In order to obtain flame-retardant recycled PET (rPET) copolymer having a lower residual amount of DEG (<1.4 wt.-% DEG), the diethylene glycol (DEG) content of the monomeric rBHET is selected from 0.1 to 1 weight-%, in combination within the other set of parameters

Preferably, the monomeric rBHET used in the instant invention has a humidity (water) content of at most 3 wt-%, more preferred of at most 2 wt-%.

Preferably, the monomeric rBHET used in the instant invention has a crystallinity of at least 80%, more preferred of at least 90%, in particular preferred of at least 95%, based on the dry weight of the monomeric rBHET material. Using monomeric rBHET having the aforementioned crystallinity reduces the risk of breakage and/or deformation as well as the formation of agglomerates during handling.

Preferably, the monomeric rBHET used in the instant invention has a particle size in the range from 0.1 to 10 mm, more preferred from 0.5 to 8 mm, in particular preferred from 3 to 7 mm. By additionally selecting the particle size within the above ranges for the monomeric rBHET, it is possible to control the melting behavior of the monomeric rBHET during the manufacture of the flame retardant recycled PET (PET) and the residence time in the reactor, in particular in the polycondensation reactor.

The flame-retardant recycled PET (rPET) copolymer of the instant invention is manufactured by melting the monomeric rBHET in stirred vessel, typically at temperatures of about 110 to 140° C., under ambient pressure. Next, additives, such as catalysts, delusterants, other functional additives, as well as the phosphorus functional comonomer, are added to the molten rBHET in the stirred vessel, typically under stirring. Thereafter, the temperature is increased to about 250° C. and the hot reaction mixture is discharged to the polycondensation vessel. The pressure in the polycondensation vessel is reduced, typically to about 100 mbar, and volatile components, as well as volatile ethylene glycol, are removed, typically under stirring. Upon completion of the ethylene glycol removal, the temperature of the polycondensation vessel is increased to about 280° C. and the pressure is further reduced, typically to about 1 mbar and below. The polycondensation is completed until a targeted torque at the stirrer is reached. The flame-retardant recycled PET (rPET) copolymer is discharged from the polycondensation vessel and extruded to chips or directly fed to a melt spinning device for melting of flame retardant recycled PET (rPET) copolymer fibers.

The flame retardant recycled PET (rPET) copolymer of the instant invention has the following set of parameters:
(i) a carboxyl end group (CEG) content from 8 to 70 mmol/kg, preferably from 15 to 50 mmol/kg, and,
(ii)<1.45 weight-% of diethylene glycol (DEG).
(iii) molecular weight corresponding to an intrinsic viscosity (IV) between 0.4 to 1.6 dl/g measured on solutions in dichloroacetic acid at 25° C.

Materials are considered as flame-retardant, if such materials satisfy the provisions of DIN 4102B1.

The flame-retardant recycled PET (rPET) copolymer obtained from the instant monomeric rBHET has a controlled residual diethylene glycol (DEG) content, or in other words the DEG content can be adjusted by selecting the appropriate monomeric rBHET raw material.

Thus, a further subject matter of the instant invention is a flame retardant recycled PET (rPET) copolymer having
(i) a carboxyl end group (CEG) content from 8 to 70 mmol/kg, preferably from 15 to 50 mmol/kg, and,
(ii)<1.45 weight-% of diethylene glycol (DEG) and,
(iv) molecular weight corresponding to an intrinsic viscosity (IV) between 0.4 to 1.6 dl/g measured on solutions in dichloroacetic acid at 25° C. and,
(vi) said copolymer having a phosphor content of 0.01 to 3 wt. % based on total weight of polymer material,
(vii) said phosphor content is covalently bond to the polymer backbone, by mixing and polycondensation of monomeric rBHET material comprising (i) at least 75 weight-% of bis(2-hydroxyethyl) terephthalate (BHET), preferably at least 90 weight-% of bis(2-hydroxyethyl) terephthalate (BHET), based on the dry weight of the monomeric rBHET material and,
(ii) 0.3 to 8 weight-% of mono(2-hydroxyethyl) terephthalate (MHET), preferably 0.3 to 2.5 weight-% of mono(2-hydroxyethyl) terephthalate (MHET), based on the dry weight of the monomeric rBHET material and
(iii) 1 to 20 weight-% of linear oligomers based on the dry weight of the monomeric rBHET material and,
(iv) optionally 0.001 to 0.1 weight-% cyclic oligomers, based on the dry weight of the monomeric rBHET material and,
(v) a carboxyl end group (CEG) content from 8 to 70 mmol/kg, preferably from 15 to 50 mmol/kg, and,
(vi) a saponification value corresponding to a range from 430 to 450 mg KOH/g and;
(vii) 0.1 to 2.5 weight-%, preferably 0.1 to 2.0 weight-%, more preferred 0.5 to 1.6 weight-%, of diethylene glycol (DEG),
and phosphorus functional comonomers as defined in Formula (I) and/or Formula (II),

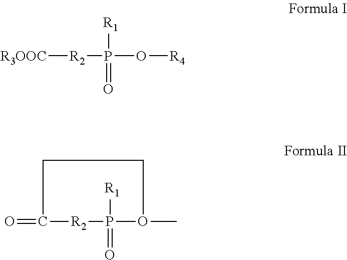

in which the radicals have the following meaning
R¹ is equal to alkyl, aryl, alkyl-aryl, aryl-alky, preferably C₁-C₁₀-alkly or C6-C10-aryl, more preferably CH₃ or C₆H₅,
R² is equal to —(CH₂)ₓ—,
x being an integer from 1 to 6, preferably x=2
R³, R⁴ is equal to H, —(CH₂)_{y}—OH, (CH₂)_{z}—O—(CH₂)_{z}OH, preferably (CH₂)₂—OH, (CH₂)₂—O—(CH₂)₂OH, CH₂—CH₂—CH₂—CH₂OH, CH₂—CH₂—CH₂OH
y being an integer from 1 to 6, preferably from 1 to 4,
z being an integer from 1 to 6, preferably from 1 to 4, more preferred z is 2.

By using the above monomeric rBHET it is possible to produce flame-retardant recycled PET (rPET) copolymer having a low residual diethylene glycol (DEG) content of less than 1.45 weight-%, preferably 1.4 weight-% or less, more preferred 1.3 weight-% or less, more preferred 1.2 weight-% or less, based on the weight of the final flame-retardant recycled PET (rPET) copolymer. In contrast, commercially available flame-retardant PET copolymer, typically, have a residual diethylene glycol (DEG) content of 1.48 to 1.5 weight-% of residual diethylene glycol (DEG).

In addition, it is surprising that by using the above monomeric rBHET even higher phosphorous content in the flame-retardant recycled PET (rPET) copolymer are possible, even the presence of such phosphorous materials contributes to the formation of residual diethylene glycol (DEG) in the polymer. Thus, by using the above monomeric rBHET comprising up to 2.5 weight-%, preferably 1.5 to 2.5 weight-%, more preferred 1.8 to 2.5 weight-%, of diethylene glycol (DEG), flame-retardant recycled PET (rPET) copolymers having a phosphorous content of at least 6700 mg/kg are possible, preferably such flame-retardant recycled PET (rPET) copolymers having a melting temperature of below 242° C., in particular below 240° C.

Generally, polymer properties like melting behavior, crystallization behavior, crystallinity, etc. can be controlled by controlling the DEG-content in the polymer. In addition, the dyeability of the fiber obtained from such flame-retardant recycled PET (rPET) copolymer can be controlled and set by selecting the diethylene glycol (DEG) content of the monomeric rBHET used for manufacturing the flame-retardant recycled PET (rPET) copolymer. This allows to select and control the diethylene glycol (DEG) content of the flame-retardant recycled PET (rPET) copolymer, as such residual diethylene glycol (DEG) content impacts various polymer properties, including the dyeability of the fiber obtained from such materials.

In principle, monomeric rBHET is available from Ioniqa, having offices at De Lismortel 31, 5612 AR Eindhoven, The Netherlands or Jeplan, having offices at 12-2 Ogimachi, Kawasaki-ku, Kawasaki, 210-0867, Japan.

Preferably, the entire formation of the flame retardant recycled PET (rPET) copolymer is in the absence of virgin fossil PTA or virgin fossil MEG.

In a preferred embodiment, the rBHET is obtained from using a bio-derived and/or recycled MEG to glycolyze PET to be recycled, as defined in WO 2016/140901 A1 and U.S. Pat. No. 11,352,718, which are each incorporated by reference herein in their entireties, to define the terms bio-based or bio-derived.

In a preferred embodiment, the rBHET is reacted in the presence of bio-derived and/or recycled PTA, as defined in WO 2016/140901 A1 and U.S. Pat. No. 11,352,718, which are each incorporated by reference herein in their entireties, to define the terms bio-based or bio-derived.

In a preferred embodiment, the rBHET is reacted in the presence of bio-derived and/or recycled DMT, as defined in WO 2016/140901 A1 and U.S. Pat. No. 11,352,718, which are each incorporated by reference herein in their entireties, to define the terms bio-based or bio-derived.

Apparatuses useful in preparing the filamentous material complex constructs of the present invention are conventional in nature and known to one skilled in the art. Such apparatuses include extruders, spinners, drawing godets, ovens, coolers, conveyor lines, water/air jets, winders/rewinders or unwinders, topical applicators, calenders, compactors, balers/openers and the like.

We have successfully engineered the production process for maximum flexibility: to be able to use natural and non-nutritional bio-based feed stocks and/or to utilize advanced recycled PET waste streams. Key is to track and respect the entire textile value added chain and its raw materials, as well as fabric collection possibilities, in order to treat used fabrics as valuable raw materials for further reusage.

The present invention illustrates the first successful steps towards developing a commercial scale circular textile economy focusing on flame retardant man-made fibers and yarns. The three-step holistic approach includes one of several exemplary processes wherein: 1. production of rPET using a mix of recycled and bio-sourced raw materials (pre-life); 2. application of this rPET with a stable flame-retardant polymer modification for environmentally conscious high-performance fabrics; and 3. a take back system to ensure raw materials are returned as a feed stock into the next production process-collectively forming a circular economy (post-life). In addition, the present invention provides a pathway towards flame-retardant recycled PET (rPET) copolymer having residual diethylene glycol (DEG) content being lower or higher than flame-retardant PET from current commercial processes. Furthermore, it is surprising that by using the above monomeric rBHET even higher phosphorous content in the flame-retardant recycled PET (rPET) copolymer are possible, such as 0.7 wt. % and more phosphor content based on total weight of polymer material, even the presence of such phosphorous materials contributes to the formation of residual diethylene glycol (DEG) in the polymer.

While a preferred embodiment of the present invention is directed toward a flame retardant rPET that is fully or mostly comprised of either fully recycled components and/or bio-derived components, it will be understood that blends of the virgin components (e.g., PTA or MEG) and non-virgin components (e.g., PTA or MEG) could be utilized in many different applications.

The flame retardant rPET may come in a variety of forms, such as pellets, chips, flakes, etc. for conversion into various thermoplastic constructs, including molded, extruded, sprayed, or other methods.

The resulting flame retardant rPET of the present invention may be used as fibers to make textile fabrics, such as woven, knitted, nonwoven and/or fabrics, including blends, laminates, composites with the same or differing flame-retardant properties through the resultant fabric material.

It will be understood that the present flame retardant rPET compositions, in particular as fibers, are not constrained by particular cross-sectional profiles, and that the present invention contemplates that the resulting polymer material can have round, oval and other suitable cross sections, such as star, or also other shapes, such as dumbbell-shaped, kidney-shaped, octalobal and dog-bone, triangular, or tri- or multi-lobal cross sections. Hollow variants as well as blends of cross-sectional profiles are also possible.

Polymeric compositions of the present invention may be produced by melt-spinning first and second polymer blends to form conjugate fibrous material having plural fibrous components. This form of fibrous material, sometimes referred to a bicomponent or multi-component, can take a number of configurations, such as including fibrous components in a sheath/core cross-sectional configuration, a side-by-side configuration, a segmented pie or split configuration, a so-called “islands-in-the-sea” configuration, as well as other arrangements and blends thereof, including use of monocomponent cross-sectional structures, as are known in the art.

Polymeric compositions of the present invention may be formed from blends of two or more polymers may also be used, wherein additives to each polymer may differ, including copolymers and alloys.

The one or more polymers may have different levels of functional additives (e.g., flame retardant) or compositions, blends of different functional additives (two or more flame retardant additives) and may include one or more different levels of secondary functional (such as antimicrobial, friction modifiers, adsorbers/absorbers, and skin wellness) and/or aesthetic (such as pigments, delusterants, and opacifiers) additives or compositions. Further, the resulting material produced by the polycondensation reaction may optionally undergo one or more separate processes where additional functional and/or aesthetic modification is made to the first flame-retardant material, including without limitation the treatment of the material with a secondary flame-retardant chemistry or technology.

The flame retardant rPET copolymer of the instant invention is a raw material for melt-spinning of flame retardant rPET copolymer fibers. Such melt-spinning forms continuous filament of the flame retardant rPET copolymer which can be chopped to staple fibers as well or drawn by established drawing processes into high tenacity filament. Further, fibers of the flame retardant rPET copolymer are useful for forming yarn, woven and nonwoven fabrics, including nonwovens.

The flame-retardant rPET copolymer fibers are useful for producing nonwovens, wovens, knits and the like and also correspondingly made-up articles such as apparel and underwear textiles, sport textiles, home textiles and bedding, hygiene and medical textiles, automotive textiles, textiles for aerospace, food packaging, industrial textiles for building and filtration, towels.

The fibrous products are produced by methods which are familiar to one of ordinary skill in the art, i.e., wovens and formed-loop knits are produced using customary machines, nonwovens can be produced for example from staple fibers or from continuous filament fibers here for example by the spunbond process. Nonwovens, wovens and knits as per the invention can also be processed to form layered products or composites and also to form shaped articles.

The flame-retardant functionality of the flame-retardant rPET copolymer fibers is integrated in the polymer backbone by a covalent chemical bond and thus the flame retardant properties are permanent and is only minimally reduced by washing and wearing. In contrast, flame retardant functionality lateron applied to the fiber, e.g. as sizing, are significantly faster reduced by washing and wearing. The co-condensed phosphorus compounds are integrated in the polymer backbone by a covalent chemical bond and cannot migrate out and lead to an appreciably lower allergy potential, if any.

The flame-retardant rPET copolymer fibers are in the form of staple fibers, filaments and as monofils for constructing the respective textiles.

The flame-retardant rPET copolymer fibers can be constructed entirely from the flame-retardant rPET copolymer having the co-condensed phosphorus-containing chain members. In a further embodiment, it is also possible to use so-called multicomponent fibers.

Multicomponent fibers combine multiple different raw materials in one fiber. Examples are bicomponent fibers which are constructed as core-sheath or side-by-side fibers. In such arrangement, one part of side-by-side filaments or the sheath, in case of core-sheath fiber, consists of the flame-retardant rPET copolymer and the other component typically provides for thermos-bonding of the fibrous material through a melting point being at least 5° C., more preferred at least 10° C., lower than the melting point of the flame-retardant rPET copolymer.

Of particular advantage for the purposes of the invention are fibrous products which contain the flame-retardant rPET copolymer as sheath material in core-sheath fibers. Said sheath component is 50% or less based on the area cross-section of the multicomponent fiber, especially 15-50%, preferably 15-25%.

In a further embodiment of the invention, the flame-retardant rPET copolymer fibers are used as so-called hybrid fibers or hybrid yarns. These hybrid fibers or yarns consist of multiple, preferably two, polymer components, of which one has a melting point which is at least 10° C. lower than the other. At least one of the aforementioned components are the flame-retardant rPET copolymer fibers according to the instant invention.

The production of corresponding flame-retardant polyester fibers in which the polyester comprises co-condensed phosphorus-containing chain members is known per se. Reference is made here to the following German patent applications or patent specifications, the disclosure content of which is hereby expressly incorporated herein: DE 2,236,037 A1, DE 2,242,002 A1, DE 2,346,787 B1, DE-2,454, 189 B1.

### EXAMPLES

Used BHET material samples:

| | | VZ | | linear | cyclic | | |
|---|---|---|---|---|---|---|---|
| | DEG | (mg | CEG | Oligomers | Oligomers | BHET | MHET |
| | (%) | KOH/g) | (mmolH+/kg) | (%) | (%) | (%) | (%) |
| BHET- | 0.2 | 441.3 | 19.8 | 5.06 | 0.011 | 94.919 | 0.01 |
| A2 | | | | | | | |
| BHET- | 1.78 | 436.6 | 68.3 | 5.808 | 0.046 | 92.515 | 1.467 |
| B1 | | | | | | | |
| BHET- | 0.98 | 437.4 | 65.5 | 4.742 | 0.086 | 94.145 | 0.99 |
| B2 | | | | | | | |

### Example 1

FR (Flame Retardant), 100% BHET materialH

BHET is a steel vessel and heated to 110° C. at ambient pressure. In the course of increasing temperature to 140° C. the BHET is melted. Antimony glycolate is added dissolved in MEG, TiO₂ as a slurry in MEG, 3-(hydroxyphenylphosphinyl) propanoic acid (3-HPP) dissolved in MEG (50%). Reaction temperature then increased to 250° C. and transferred to the polycondensation vessel. Pressure inside the reactor is then decreased to 100 mbar until all excess MEG has been removed. Polycondensation is then carried out at pressures below 1 mbar at 280° C. The reactor is discharged upon reaching the targeted stirrer torque level.

### FR-PET:

| | IV | CEG | DEG | TiO₂ | Sb | P | Tₘ |
|---|---|---|---|---|---|---|---|
| | (dl/g) | (mmolH+/kg) | (%) | (%) | (mg/kg) | (mg/kg) | (° C.) |
| BHET- | 0.618 | 19 | 1.12 | 0.035 | 184 | 6721 | 243.2 |
| A2 | | | | | | | |
| BHET- | 0.636 | 20.7 | 2.16 | 0.034 | 194 | 6878 | 238 |
| B1 | | | | | | | |
| BHET- | 0.635 | 20 | 1.57 | 0.034 | 186 | 6714 | 239 |
| B2 | | | | | | | |
| BHET- | 0.629 | 19.7 | 1.43 | 0.034 | 2 | 6350 | 239.9 |
| B2 | | | | | | | |
| BHET- | 0.608 | 18.6 | 1.35 | 0.285 | 3 | 6163 | 240.2 |
| B2 | | | | | | | |

### COMPARATIVE EXAMPLE

### FR, Virgin PTA

| IV | CEG | DEG | Sb | P | TiO2 | m.p. |
|---|---|---|---|---|---|---|
| 0.631 | 34.7 | 1.48% | 290 | 0.64% | 0.40% | 244° C. |
| dl/g | meq/kg | | ppm | | | |

### Example 2

### Fiber Spinning

The flame-retardant rPET copolymer is melt-spun to flame-retardant rPET copolymer fibers using the polymers of Example 1 using existing commercial devices and methods known to the skilled worker. For details see, for example, U.S. Pat. Nos. 3,816,486, 4,639,347, GB 1 254 826 and JP 11-189938.

1. A flame-retardant recycled PET (rPET) copolymer having
(i) a carboxyl end group (CEG) content from 8 to 70 mmol/kg, and
<1.45 weight-% of diethylene glycol (DEG), and
(iii) a molecular weight corresponding to an intrinsic viscosity (IV) between 0.4 to 1.6 dl/g measured on solutions in dichloroacetic acid at 25° C.
(vi) said copolymer having a phosphor content of 0.01 to 3 wt. % based on total weight of polymer material,
(vii) said phosphor content is covalently bonded to the polymer backbone, obtained by mixing and polycondensation of monomeric rBHET material comprising
(i) at least 75 weight-% of bis(2-hydroxyethyl) terephthalate (BHET), based on the dry weight of the monomeric rBHET material and
(ii) 0.3 to 8 weight-% of mono(2-hydroxyethyl) terephthalate (MHET), based on the dry weight of the monomeric rBHET material and
(iii) 1 to 20 weight-% of linear oligomers based on the dry weight of the monomeric rBHET material and,
(iv) optionally 0.001 to 0.1 weight-% cyclic oligomers, based on the dry weight of the monomeric rBHET material and,
(v) a carboxyl end group (CEG) content from 8 to 70 mmol/kg, and,
(vi) a saponification value corresponding to a range from 430 to 450 mg KOH/g and;
(vii) 0.1 to 2.5 weight-% of diethylene glycol (DEG),
and phosphorus functional comonomers as defined in Formula (I) and/or Formula (II), 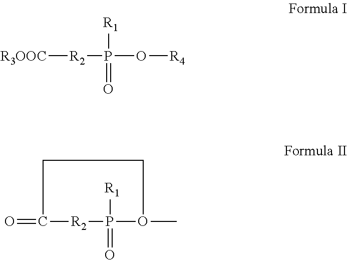
in which the radicals have the following meaning
R¹ is equal to alkyl, aryl, alkyl-aryl, aryl-alky,
R² is equal to —(CH₂)ₓ—,
x being an integer from 1 to 6, preferably x=2
R³, R⁴ is equal to H, —(CH₂)_{y}—OH, (CH₂)_{z}—O—(CH₂)_{z}OH,
y being an integer from 1 to 6,
z being an integer from 1 to 6.

2. The flame-retardant recycled PET (rPET) copolymer as claimed in claim 1, wherein the flame-retardant functional additive is 3-(hydroxyphenylphosphinyl) propanoic acid (3-HPP).

3. The flame-retardant recycled PET (rPET) copolymer as claimed in claim 1, wherein the monomeric rBHET has a humidity (water) content of at most 3 wt-%.

4. The flame-retardant recycled PET (rPET) copolymer as claimed in claim 1, wherein the monomeric rBHET has a particle size in the range from 0.1 to 10 mm.

5. The flame-retardant recycled PET (rPET) copolymer as claimed in claim 1, wherein the flame-retardant recycled PET (rPET) copolymer is obtained by polycondensation of i) monomeric rBHET and ii) phosphorus functional comonomer, without adding a) any virgin fossil purified terephthalic acid (PTA), or b) virgin fossil dimethyl terephthalate (DMT), or c) virgin fossil monoethylene glycol (MEG).

6. The flame-retardant recycled PET (rPET) copolymer as claimed in claim 1, wherein the flame-retardant recycled PET (rPET) copolymer having a low residual diethylene glycol (DEG) content of 1.4 weight-% or less, based on the weight of the final flame-retardant recycled PET (rPET) copolymer.

7. The flame-retardant recycled PET (rPET) copolymer as claimed in claim 1, wherein the flame-retardant recycled PET (rPET) copolymer has a phosphorous content of at least 6700 mg/kg, by using a monomeric rBHET as defined in claim 1, said monomeric rBHET comprising up to 2.5 weight-%.

8. Melt-Spun fibers comprising the flame retardant rPET copolymer according to claim 1.

9. Textile fabrics, preferably nonwoven or woven or knitted fabrics, comprising fibers comprising the flame retardant rPET copolymer according to claim 1.

10. A method of using textile fabrics comprising fibers comprising the flame retardant rPET copolymer according to claim 1 for producing made-up articles such as apparel and underwear textiles, sport textiles, home textiles and bedding, such as window coverings, wall coverings, carpets and mattresses, hygiene and medical textiles, automotive textiles, textiles for aerospace, food packaging, industrial textiles for building and filtration, towels and personal protection equipment.

11. The flame-retardant recycled PET (rPET) copolymer according to claim 1, wherein the carboxyl end group (CEG) content is from 15 to 50 mmol/kg.

12. The flame-retardant recycled PET (rPET) copolymer according to claim 1, further wherein:
R¹ is equal to C₁-C₁₀-alkly, C₆-C₁₀-aryl, CH₃, or C₆H₅;
R³, R⁴ is equal to (CH₂)₂—OH, (CH₂)₂—O—(CH₂)₂OH, CH₂—CH₂—CH₂—CH₂OH, CH₂—CH₂—CH₂OH;
y being an integer from 1 to 4; and
Z being an integer from 1 to 4.

13. The flame-retardant recycled PET (rPET) copolymer according to claim 1, wherein the flame-retardant recycled PET (rPET) copolymer having a low residual diethylene glycol (DEG) content of 1.2 weight-% or less, based on the weight of the final flame-retardant recycled PET (rPET) copolymer.

14. The flame-retardant recycled PET (rPET) copolymer according to claim 7, wherein said monomeric rBHET comprises 1.5 to 2.5 weight-% of diethylene glycol (DEG).

15. The flame-retardant recycled PET (rPET) copolymer according to claim 1, wherein the monomeric rBHET material comprises 0.5 to 1.6 weight-% of diethylene glycol (DEG).

16. The flame-retardant recycled PET (rPET) copolymer according to claim 1, wherein the monomeric rBHET has a humidity (water) content of at most 2 wt-%.

17. The flame-retardant recycled PET (rPET) copolymer according to claim 1, wherein the monomeric rBHET has a particle size in the range from 0.5 to 8 mm.

18. The flame-retardant recycled PET (rPET) copolymer according to claim 1, wherein the monomeric rBHET has a particle size in the range from 3 to 7 mm.

19. A flame-retardant recycled PET (rPET) copolymer comprising:
(i) a carboxyl end group (CEG) content from 15 to 50 mmol/kg, and
(ii)<1.45 weight-% of diethylene glycol (DEG), and
(iii) a molecular weight corresponding to an intrinsic viscosity (IV) between 0.4 to 1.6 dl/g measured on solutions in dichloroacetic acid at 25° C.
(vi) said copolymer having a phosphor content of 0.01 to 3 wt. % based on total weight of polymer material,
(vii) said phosphor content is covalently bonded to the polymer backbone, obtained by mixing and polycondensation of monomeric rBHET material comprising
(i) at least 90 weight-% of bis(2-hydroxyethyl) terephthalate (BHET), based on the dry weight of the monomeric rBHET material and,
(ii) 0.3 to 2.5 weight-% of mono(2-hydroxyethyl) terephthalate (MHET), based on the dry weight of the monomeric rBHET material and
(iii) 1 to 20 weight-% of linear oligomers based on the dry weight of the monomeric rBHET material and,
(iv) optionally 0.001 to 0.1 weight-% cyclic oligomers, based on the dry weight of the monomeric rBHET material and,
(v) a carboxyl end group (CEG) from 15 to 50 mmol/kg, and
(vi) a saponification value corresponding to a range from 430 to 450 mg KOH/g and;
(vii) 0.1 to 2.0 weight-% of diethylene glycol (DEG), and phosphorus functional comonomers as defined in Formula (I) and/or Formula (II), 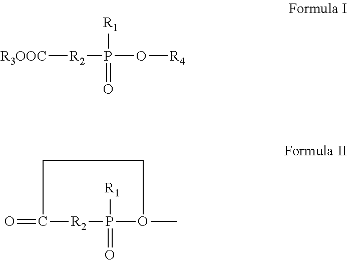
in which the radicals have the following meaning
R¹ is equal to alkyl, aryl, alkyl-aryl, aryl-alky,
R² is equal to —(CH₂)ₓ—,
x being an integer from 1 to 6,
R³, R⁴ is equal to H, —(CH₂)_{y}—OH, (CH₂)_{z}—O—(CH₂)_{z}OH,
y being an integer from 1 to 6, and
z being an integer from 1 to 6.

20. The flame-retardant recycled PET (rPET) copolymer according to claim 19, further wherein:
R¹ is equal to C₁-C₁₀-alkly, C₆-C₁₀-aryl, CH₃, or C₆H₅;
x being an integer equal to 2;
R³, R⁴ is equal to (CH₂)₂—OH, (CH₂)₂—O—(CH₂)₂OH, CH₂—CH₂—CH₂—CH₂OH, CH₂—CH₂—CH₂OH;
y being an integer from 1 to 4; and
z being an integer equal to 2.
